(19) United States
(12) Patent Application Publication
(10) Pub. No.: US 2004/0086367 A1
(43) Pub. Date: May 6, 2004

(54) Transport cart

(76) Inventor: Harold Isaacs, University Heights, OH (US)

Correspondence Address: Howard M. Cohn, Suite 220, 21625 Chagrin Blvd., Cleveland, OH, 44122, US

(21) Appl. No.: 10/691,906

(22) Filed: Oct. 23, 2003

Related U.S. Application Data
(60) Provisional application No. 60/420,686, filed on Oct. 23, 2002.

(51) Int. Cl. B60P 1/02; B62B 1/00; B65G 69/00; B62B 5/00

(52) U.S. Cl. 414/679; 280/79.3; 414/495

(57) ABSTRACT

The present invention relates to a structural frame, supporting a movable saddle. The structural frame comprises a motion guidance system including at least one guide column secured to the structural frame and a carriage movable along the guide column and secured to the structural frame, the motion guidance system including an anti-rotation bearing support affixed to the carriage and movably secured to the structural frame; and a support device connected to the structural frame and a saddle for controlling the location of the saddle with respect to the structural frame.

### CROSS-REFERENCE TO RELATED APPLICATIONS

This application claims the benefit of U.S. Provisional Patent Application No. 60/420,686 filed on Oct. 23, 2002 which is incorporated herein by reference.

### TECHNICAL FIELD

The present invention relates generally to a transport cart capable of carrying stacked rows of work containers and more particularly to an ergonomic transport cart adapted to maintain a row of the work containers at a predetermined height.

### BACKGROUND ART

In the past, transport carts were used for carrying stacked rows of work containers. For example, the U.S. Postal Service used such transport carts for stacked rows of postal baskets and bins of mail. However, postal workers were subjected to physical distress due to the extended range of horizontal reach or the hand and arm extension needed for loading the different rows of weighted baskets and bins onto the truck.

### SUMMARY OF THE INVENTION

The present invention relates to a structural frame supporting a movable saddle. The structural frame comprises a motion guidance system including at least one guide column secured to the structural frame and a carriage movable along the guide column and secured to the structural frame, the motion guidance system including an anti-rotation bearing support affixed to the carriage and movably secured to the structural frame; and a support device connected to the structural frame and a saddle for controlling the location of the saddle with respect to the structural frame.

According to the invention, the anti-rotation bearing support has a first end affixed to the saddle and an opposite end having an anti-rotation bearing; and the anti-rotation bearing adapted to ride in an anti-rotation guide channel secured to the structural frame.

Further according to the invention, the motion guidance system includes a carriage secured to and adapted to move along the length of the support tube, the carriage being interconnected to the saddle.

Still further according to the invention, the support device for controlling the location of the saddle includes at least a first spring connected at one end to the saddle and at the other end to the structural frame. Also, if desired, the at least first spring is connected at one end to the carriage and at the other end to the structural frame. Also, the at least two springs are each connected at one end to the carriage and at the other end to the structural frame.

Yet further according to the invention, the support device for controlling the location of the saddle includes an hydraulic system interconnecting the carriage and the structural frame. The hydraulic system includes a hydraulic cylinder with a piston that moves in and out of the cylinder and includes an idler at one end; and a cable attached to one end of the piston and attached to the carriage at the other end wherein movement of the piston in the cylinder causes movement of the carriage and the saddle to which it is attached.

Also according to the invention, the carriage includes a first set of bearings mounted thereto and a second set of bearings mounted thereto, the first and second set of bearings being adapted to engage the guide column to ensure that the carriage can move vertically up and down on the guide column. The first and second set of bearings are at spaced locations from each other.

The present invention also relates to an embodiment of a transport cart including a structural frame supporting a movable saddle, comprising: a motion guidance system including at least one guide column secured to the structural frame and a carriage movable along the guide column and secured to the structural frame, the motion guidance system including an antirotation bearing support affixed to the carriage and movably secured to the structural frame; a wheel system attached to the structural frame for moving the transport cart; and a support device connected to the structural frame and the saddle for controlling the location of the saddle with respect to the structural frame.

According to the invention of a transport cart, the anti-rotation bearing support has a first end affixed to the saddle and an opposite end having an anti-rotation bearing; and the anti-rotation bearing adapted to ride in an anti-rotation guide channel secured to the structural frame.

Further according to the invention of a transport cart, the motion guidance system includes a carriage secured to and adapted to move along the length of the support tube, the carriage being interconnected to the saddle.

Still further according to the invention of a transport cart, the support device for controlling the location of the saddle includes at least a first spring connected at one end to the saddle and at the other end to the structural frame. Also, if desired, the at least first spring is connected at one end to the carriage and at the other end to the structural frame. Also, the at least two springs are each connected at one end to the carriage and at the other end to the structural frame.

Yet further according to the invention of a transport cart, the support device for controlling the location of the saddle includes an hydraulic system interconnecting the carriage and the structural frame. The hydraulic system includes a hydraulic cylinder with a piston that moves in and out of the cylinder and includes an idler at one end; and a cable attached to one end of the piston and attached to the carriage at the other end wherein movement of the piston in the cylinder causes movement of the carriage and the saddle to which it is attached.

Also according to the invention of a transport cart, the carriage includes a first set of bearings mounted thereto and a second set of bearings mounted thereto, the first and second set of bearings being adapted to engage the guide column to ensure that the carriage can move vertically up and down on the guide column. The first and second set of bearings are at spaced locations from each other.

### BRIEF DESCRIPTION OF THE DRAWINGS

These and further features of the present invention will be apparent with reference to the following description and drawing, wherein:

FIG. 1 is a plan view showing a transport cart supporting 0, according to the present invention;

FIG. 2 is a schematic side view showing the transport cart of FIG. 1 in the loaded position, according to the present invention;

FIG. 3 is a plan showing the transport cart of FIG. 1 loaded with containers, according to the present invention;

FIG. 4 is a plan view showing a transport cart with a plurality of adjacent material stacking columns disposed on either side of a transport cart, according to the present invention;

FIG. 5 is an enlarged side view showing the details of the carriage mounted to a guide column and the anti-rotation bearing connection with the guide channel of the transport cart of FIGS. 1 and 2;

FIG. 6 is a side view through line 6-6 of FIG. 5 showing the details of the carriage mounted to a guide column of the frame and the anti-rotation bearing connection with the guide channel of the transport cart frame of FIG. 1;

FIG. 7 is a side view of an embodiment of the invention wherein the vertical motion guidance system includes a spring support connecting the carriage to the frame; and

FIG. 8 is a side view of another embodiment of the invention wherein the vertical motion guidance system includes a hydraulic cylinder connecting the carriage to the frame.

In the detailed description that follows, identical components have been given the same reference numerals, regardless of whether they are shown in different embodiments of the present invention. To illustrate the present invention in a clear and concise manner, the drawings may not necessarily be to scale and certain features may be shown in somewhat schematic form.

### DETAILED DESCRIPTION OF THE INVENTION

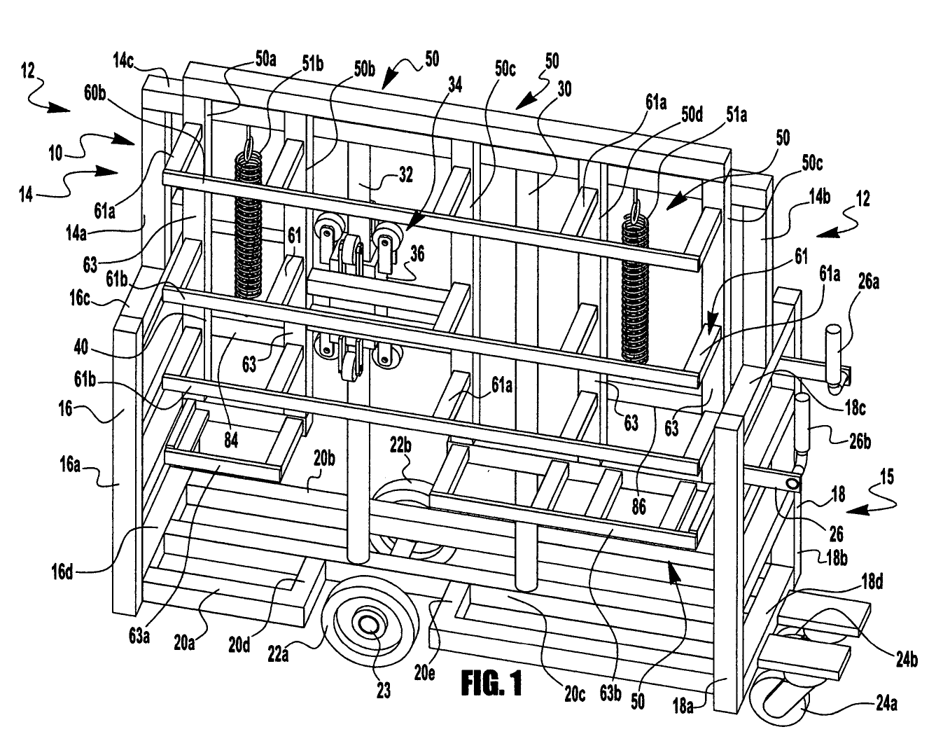

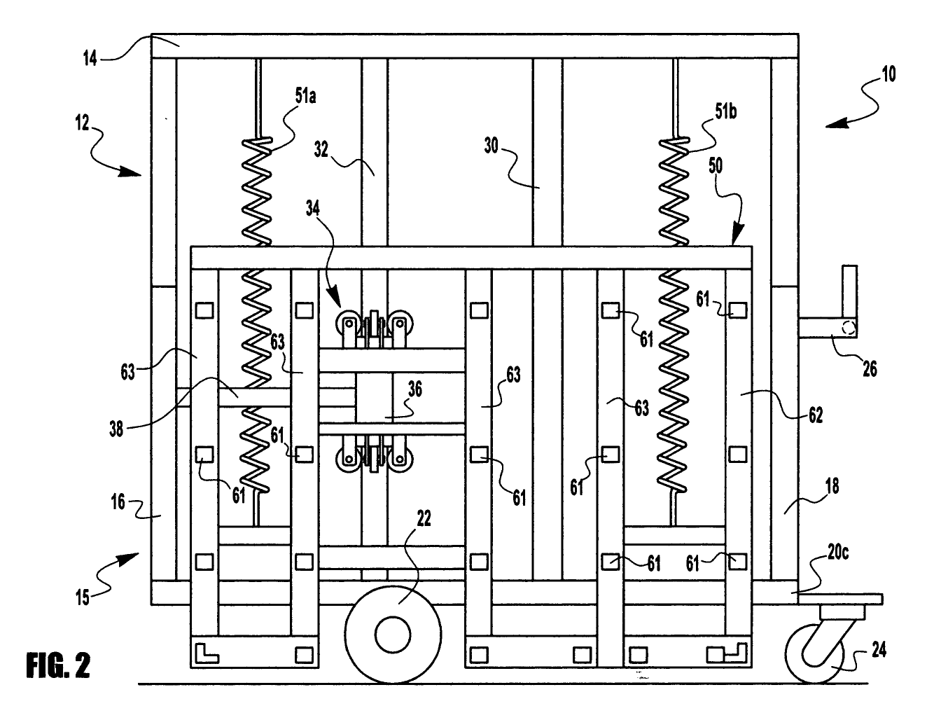

Referring to FIGS. 1 and 2, there is shown a transport cart 10 including a structural frame 12, typically constructed of a single structural weldment. The structural frame 12 includes an upper structural member 14 having two upper side supports 14a, 14b and an upper cross support 14c extending between the side supports. Frame 12 also includes a base support 15 including rectangular shaped, side structural base members 16 and 18 with spaced side base supports 16a, 16b, and 18a, 18b, respectively, upper side base supports 16c, 18c and lower base side supports 16d and 18d. Base support 15 also includes outer base support members 20a, 20b and an intermediate base support member 20c. The base support members 20b and 20c typically extend between the base side supports 16d and 18d. The base support members 20a extends to support members 20d and 20e which are spaced to provide space for the wheels 22a. The specific shape and construction of the structural frame 12 varies depending on the particular application that the transport cart 10 will be used.

A truck wheel system 21 attached to the transport cart for moving the transport cart includes a pair of primary support wheels 22a, 22b and pair of rotatable steering wheels 24a, 24b. The pair of primary support wheels 22a, 22b are mounted on an axle 23 connected to the base support members 20b, 20c. The pair of rotatable steering wheels 24a, 24b are secured to base side support 18d of the base support 15. Both sets of wheels 22a,22b and 24a,24b are mounted on two, double-opposed, shielded, greased bearings. The support wheels 22a, 22b are preferably fitted to a precisely machined axle 23, which carries between 60% and 80% and preferably about 65% to 75% of the gross weight of transport cart 10. The truck wheel system 21 of the present invention delivers a low rolling resistance of less than about 8 pounds of pushing or pulling effort (as tested on a drawbar) per 2,000 pounds of total vehicle weight on a level concrete floor. This pushing or pulling effort is less than half of the pushing or pulling effort of any other known industrial truck wheel systems. The low pushing or pulling effort facilitates manual propulsion of cart 10 without the need for powered equipment.

The transport cart 10 can be optionally equipped with a floor lock (not shown) to prevent unwanted movement while loading or unloading.

In addition, the transport cart 10 has handles 26a, 26b attached to spaced side supports 18a, 18b, respectively. The handles 26a, 26b enables a worker to locate their hands in a variety of positions, whichever is most comfortable.

An important aspect of the invention relates to guide columns 30 and 32, which are secured between the cross support 14c and intermediate base support member 20c of the structural frame 12. The guide columns 30 and 32 are disposed in parallel relation to each other. A vertical motion guidance system 34, as discussed in more detail below, is provided on at least one of the guide columns, such as column 32 in FIGS. 1 and 2.

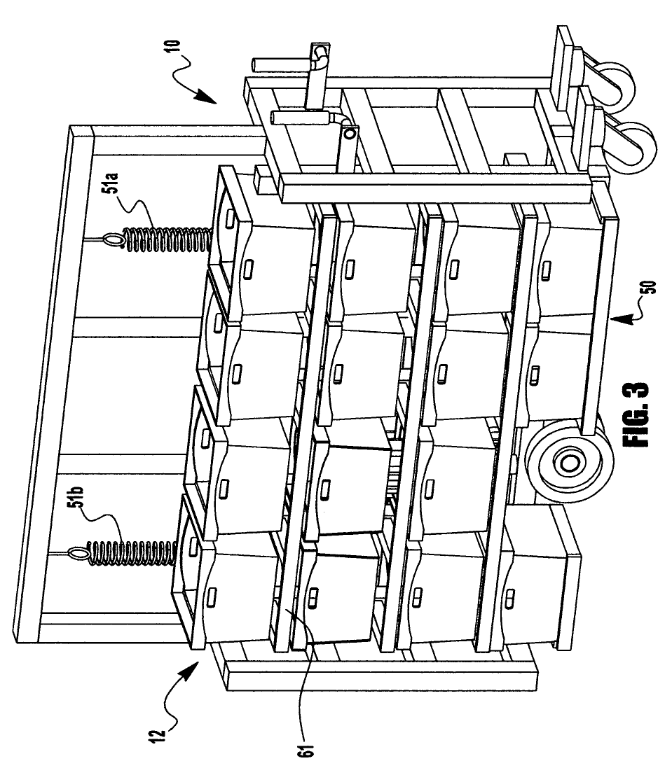

The structural frame 12 of transport cart 10 includes a receiving frame or saddle frame 50, as shown in FIGS. 1, 2 and 3, that is movably supported by the vertical motion guidance system 34 onto the upper structural member 14 by extension springs 51a, 51b and by the carriage 36 onto the column 32. The saddle 50 is provided with a matrix of interconnected, stacked ledges 61 (see FIGS. 1 and 2). The saddle includes support members 61a secured at one end to the vertical saddle frame elements 50a, 50b,50c, 50d, 50e and at the other end to elongated saddle supports 61b. The lowest ledge, closest to the support wheels 22a, 22b can have a saddle support split into support sections 63a, 63b, as shown in FIG. 1, so that the saddle 50 can move past the wheels for ease of loading, as described herein after. The ledges 61 are adapted to hold bins or boxes (see FIG. 3) or any other item of appropriate shape.

The vertical motion guidance system 34 of the present invention provides straight line machine motion with reduced friction. Therefore, any machine operation requiring straight line machine motion with reduced friction may advantageously use the structure and method of the present invention.

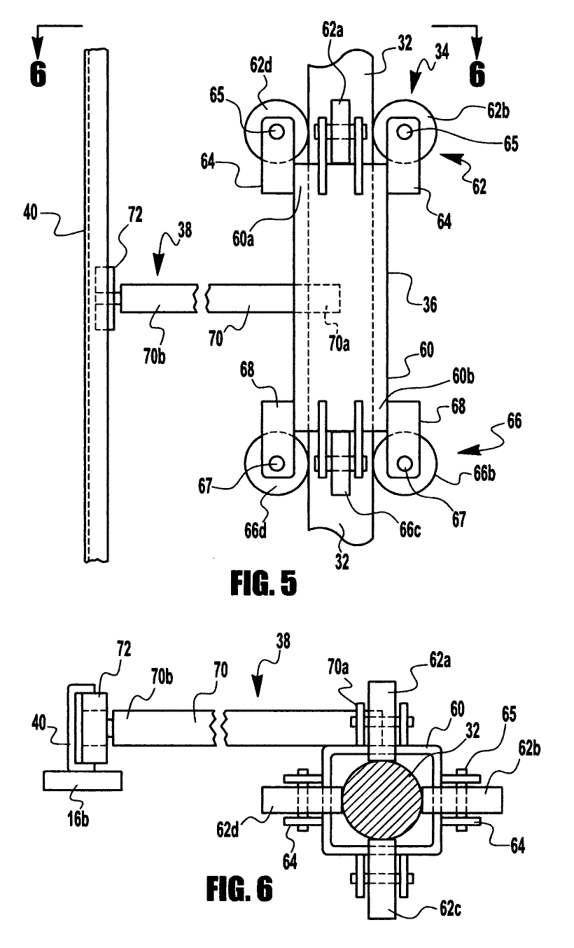

The vertical motion guidance system 34, see FIGS. 5 and 6, includes a carriage 36 and an anti-rotation bearing support 38 attached to the carriage. The anti-rotation bearing support 38 includes a rod 70 with one end 70a secured by any means such as welding to the carriage 36 and the other end 70b to an anti-rotation guide channel 40. The end 70b of the rod 70 includes a wheel 72 which rotates and allows the rod to easily move along the length of the channel 40. The channel 40 is secured by means such as welding to the side support 16b of the structural frame 12, as shown in FIG. 6. The anti-rotation bearing support 38 prevents the carriage 36 from twisting when an unbalanced load is placed or loaded on the saddle 50.

The vertical motion guidance system 34 also includes a load support for controlling the location of the saddle with respect to the structural frame. The load support can be extension springs 51a, 51b attached to both the saddle 50 and the frame 12, as shown in FIGS. 1 and 2. It is also within the scope of the invention to use the vertical motion guidance system 34 for connecting any type of frame to any machine, such as a robot or forklift truck.

The carriage 36 of the vertical motion guidance system 34, as shown in FIGS. 5 and 6, include a substantially square-shaped, support tube 60 with a first set of bearings 62 including bearings 62a, 62b, 62c and 62d, each of which mounted with a bearing holder 64 to the end 60a of support tube 60. While support tube 60 is shown with a substantially square shape, it is within the terms of the present invention to use any shaped tube-like structure. A second set of bearings 66, including bearings 66a, 66b, 66c and 66d, is mounted with the bearing holders 68 to the opposite end section 60b of support tube 60. The second set of bearings 66 is spaced from the first set of bearings 62. Each of the bearing sets 62,66 is connected to the bearing holders 64, 68, respectively, by conventional means, such as a bearing shaft 65 and 67, respectively. While four bearings are shown disposed on the support tube and around the guide column 32, it is within the scope of the present invention to use as few as three bearings, preferable spaced 120 degrees apart, or five or more bearings. Moreover, the specific type of bearing, such as for example, ball bearings or roller bearings which might be used for this invention, can vary depending on the specific application.

The provision of the bearings 62 and 66 ensure that the carriage 36 can move vertically up and down on the guide column 32 with reduced friction because the bearings are positioned or spaced with respect to each other so that they do not all have to be in contact with the column 32 at the same time. The vertical motion guidance system 34 is almost totally friction-free due to its bearing design. This design is capable of handling severe off center loading while operating freely.

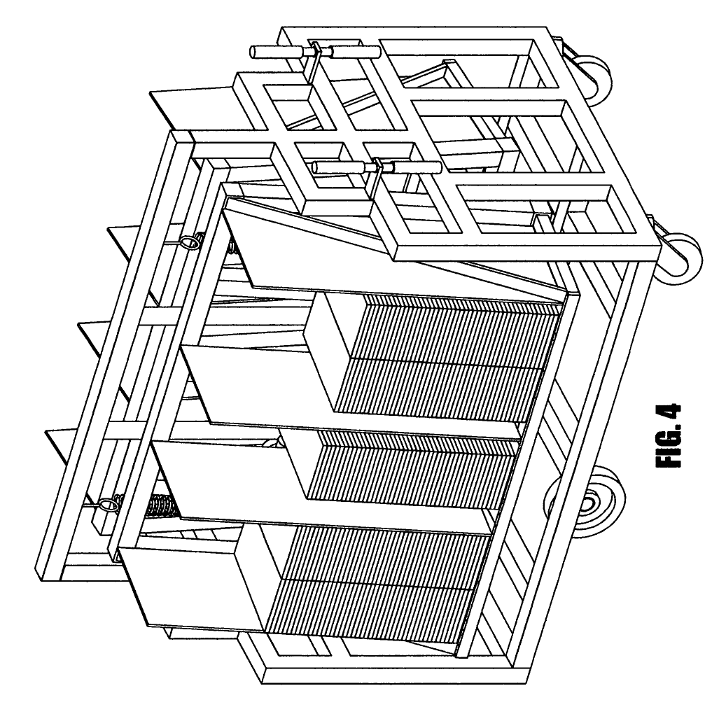

While FIGS. 1, 2 and 3 show a transport cart 10 with a receiving plate or saddle 50 on only one side, it is also within the terms of the present invention to provide a transport cart with a saddle disposed on opposite sides of the cart, as shown in FIG. 4. In this embodiment, each saddle can include a spring and a vertical motion guidance system of the type shown in the embodiment of FIGS. 1 and 2. It is also within the terms of the invention for each of the saddles to have two or more spring and a vertical motion guidance system.

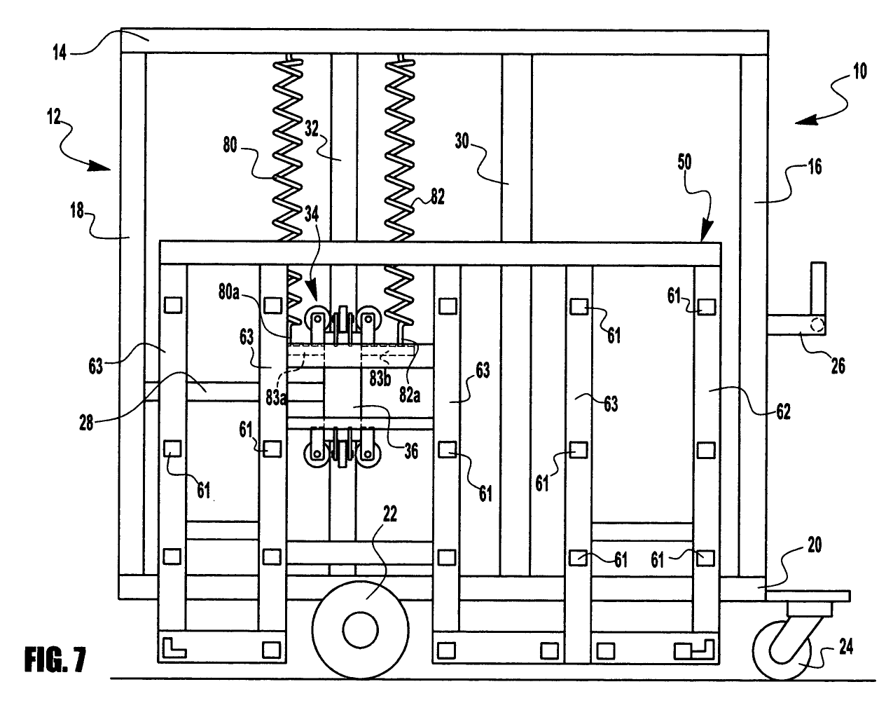

Referring to FIG. 7, there is shown a pair of extension springs 80 and 82, which are disposed about the guide column 78 (corresponding to guide column 32 in FIG. 1). The extension springs 80, 82 can be attached at one end 80a, 82a to the carriage 36 by spring attachment members 83a, 83b that are affixed to the carriage 36. While the extension springs 80,82 are both shown connected to carriage 36, it is also within the terms of the invention to connect the extension springs to a frame member of the saddle 50.

The use of springs to support the movement of the saddle on the frame is ideal for work loads of a fairly uniform and unchanging density. Work loads of up to 1,200 pounds can be accommodated. Any work load can be handled by actuating the carriage with a combination of extension springs whose total spring rate is the required number. If the work load density varies more than 30%, the ergonomic range might be extended.

In operation, the saddle 50 will move downward from the position shown in FIG. 1 to the position shown in FIGS. 2 and 3 as baskets or bins are placed on the ledges 61. That is, bins or baskets can be loaded onto the bottom ledges 61 which can be disposed at a pre-selected ergonomically advantageous height. Then, as the weight of the saddle 50 increases as more bins are placed on the ledges, the weight of the bins cause the entire tier of ledges to move downward so that a new tier of ledges is located at a pre-selected ergonomically advantageous height to receive more bins or baskets. In this manner, there is no need for an operator to stoop to load the bins, since the ledges are always presented at the proper height, as determined by the spring constant of springs 51a, 51b. The use of a single guide column 30 or 32 keeps the vertically moveable saddle 50 in alignment with the frame and avoids binding and other problems that might be present with multiple attachment points. The unique guidance system eliminates the need for the operator to keep the work load closely balanced across the length of the truck.

In the embodiment shown in FIGS. 1 and 3, which is specifically adapted for use by the Postal Service, the optimum ergonomic working height for the average worker was established as a minimum of 32 inches above the floor and a maximum of 48 inches above the floor. The frame design of the cart of the present invention permits the work load holders or containers to function with as little as only 2 inches above the floor. This provides a work load total height up to 46 inches while functioning within the ergonomic range. Maintaining the ergonomic range of the work height is also important to minimize the horizontal reach or hand and arm extension. This eliminates the need for the worker to bend down and lift up high. The improvement provided by the truck of the present invention increases employee productivity and reduces work related injuries.

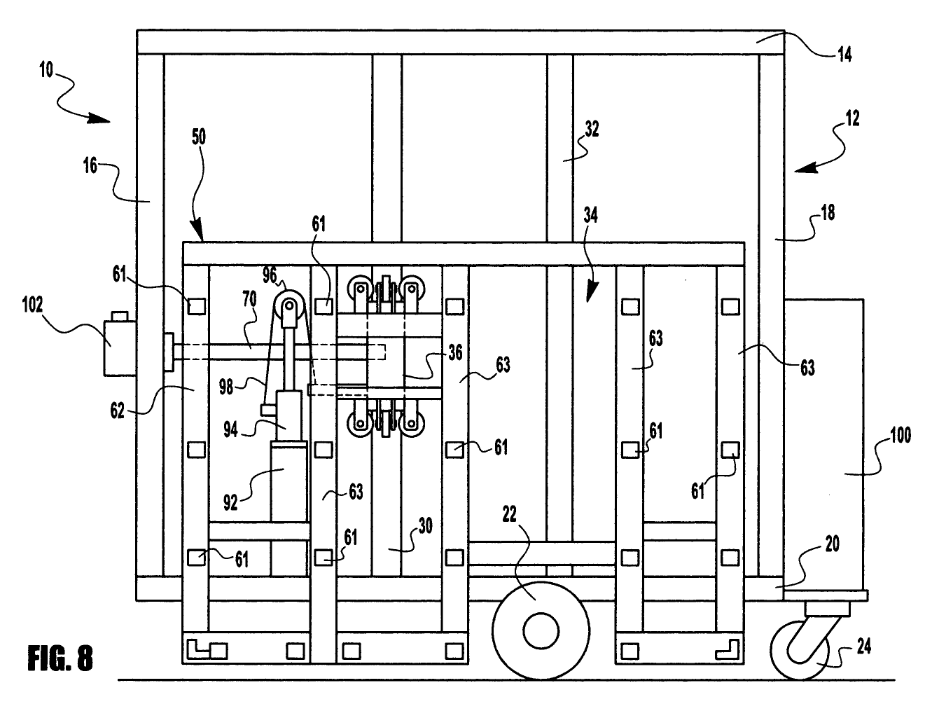

Referring to FIG. 8, the load support can be a hydraulic system 90 instead of springs to support and control the load disposed on the saddle as previously described. The hydraulic system 90 can include a hydraulic cylinder 92 with a piston 94 that moves in and out of the cylinder and includes an idler 96 at one end. A cable 98 attached at one end to the piston is wrapped around the wheel 96 and attached at the other end to the carriage 36 or to the receiving frame or saddle frame 50. The carriage 36, which moves vertically up and down on a guide column includes an anti-rotation support 70 that includes an anti-rotation bearing 72 rides in an antirotation guide channel 40, as seen in FIG. 6, and as previously discussed. The cylinder 92 can be attached to a tank 100, which includes a pump and valve system (not shown) operated manually or by a battery and motor to direct hydraulic fluid into the cylinder 92 after the control switch 102 has been activated. In operation, the cylinder 92 maintains the vertically moveable saddle 50 at a height so that the tier of ledges being loaded is positioned at an ergonomically desirable height. Both the manual and battery powered hydraulic models implement the work load ergonomic positions totally regardless of considerable differences in product density. These models, without any adjustments or changes, will readily maintain the work load ergonomic height. In fact, when required, a variety of products can be loaded at the same time.

The transport cart 10 with a vertically moving carriage is designed with a standardized receiving plate. All box or container saddles, no matter what product they are made for will quickly mount onto the carriage receiving plate. The unique guidance system eliminates the need for the operator to keep the work load closely balanced across the length of the truck.

The transport cart 10 is applicable to a very wide variety of manufacturing and distribution center operations. This includes metal stampings, aluminum die casting, plastic injection and compression molding, all manner of metal machine operations, woodworking operations and a wide variety of food processing work. The cart 10 also provides important operational advantages in printing plants, textile and clothing manufacturing as well as order picking and assembly operations.

Although the preferred embodiments of the invention have hereinabove been shown and described in detail, such embodiments should be considered to be illustrative and not restrictive in character. In this connection it is noted that numerous variations of the preferred embodiments of the invention may become apparent to persons skilled in the art as a result or having seen the foregoing drawings and read and understood the accompanying description to appertaining to the invention, and it is intended that such variations as fall within the spirit and scope the invention shall be protected to the same extent as are the preferred embodiments of the invention.

What is claimed is:

1. A structural frame supporting a movable saddle, comprising:
a motion guidance system including at least one guide column secured to the structural frame and a carriage movable along the guide column and secured to the structural frame, the motion guidance system including an anti-rotation bearing support affixed to the carriage and movably secured to the structural frame; and
a support device connected to the structural frame and a saddle for controlling the location of the saddle with respect to the structural frame.

2. The structural frame of claim 1 wherein:
the anti-rotation bearing support has a first end affixed to the saddle and an opposite end having an anti-rotation bearing; and
the anti-rotation bearing adapted to ride in an anti-rotation guide channel secured to the structural frame.

3. The structural frame of claim 1 wherein:
the motion guidance system includes a carriage secured to and adapted to move along the length of the support tube, the carriage being interconnected to the saddle.

4. The structural frame of claim 1 wherein:
the support device for controlling the location of the saddle includes at least a first spring connected at one end to the saddle and at the other end to the structural frame.

5. The structural frame of claim 3 wherein:
the at least first spring is connected at one end to the carriage and at the other end to the structural frame.

6. The structural frame of claim 5 wherein:
at least two springs are each connected at one end to the carriage and at the other end to the structural frame.

7. The structural frame of claim 3 wherein:
the support device for controlling the location of the saddle includes an hydraulic system interconnecting the carriage and the structural frame.

8. The structural frame of claim 7 wherein:
the hydraulic system includes a hydraulic cylinder with a piston that moves in and out of the cylinder and includes an idler at one end;
a cable attached to one end of the piston and attached to the carriage at the other end;
wherein movement of the piston in the cylinder causes movement of the carriage and the saddle to which it is attached.

9. The structural frame of claim 3 wherein:
the carriage includes a first set of bearings mounted thereto and a second set of bearings mounted thereto, the first and second set of bearings being adapted to engage the guide column to ensure that the carriage 36 can move vertically up and down on the guide column.

10. The structural frame of claim 9 wherein:
the first and second set of bearings are at spaced locations from each other.

11. A transport cart including a structural frame supporting a movable saddle, comprising:
a motion guidance system including at least one guide column secured to the structural frame and a carriage movable along the guide column and secured to the structural frame, the motion guidance system including an anti-rotation bearing support affixed to the carriage and movably secured to the structural frame;
a wheel system attached to the structural frame for moving the transport cart; and
a support device connected to the structural frame and the saddle for controlling the location of the saddle with respect to the structural frame.

12. The transport cart of claim 11 wherein:
the anti-rotation bearing support has a first end affixed to the saddle and an opposite end having an anti-rotation bearing; and
the anti-rotation bearing adapted to ride in an anti-rotation guide channel secured to the structural frame.

13. The transport cart of claim 11 wherein:
the motion guidance system includes a carriage secured to and adapted to move along the length of the support tube, the carriage being interconnected to the saddle.

14. The transport cart of claim 1 wherein:
the support device for controlling the location of the saddle includes at least a first spring connected at one end to the saddle and at the other end to the structural frame.

15. The transport cart of claim 13 wherein:
the at least first spring is connected at one end to the carriage and at the other end to the structural frame.

16. The transport cart of claim 15 wherein:
at least two springs are each connected at one end to the carriage and at the other end to the structural frame.

17. The transport cart of claim 13 wherein:
the support device for controlling the location of the saddle includes an hydraulic system interconnecting the carriage and the structural frame.

18. The transport cart of claim 17 wherein:
the hydraulic system includes a hydraulic cylinder with a piston that moves in and out of the cylinder and includes an idler at one end;
a cable attached to one end of the piston and attached to the carriage at the other end;
wherein movement of the piston in the cylinder causes movement of the carriage and the saddle to which it is attached.

19. The transport cart of claim 13 wherein:
the carriage includes a first set of bearings mounted thereto and a second set of bearings mounted thereto, the first and second set of bearings being adapted to engage the guide column to ensure that the carriage 36 can move vertically up and down on the guide column.

20. The transport cart of claim 19 wherein:
the first and second set of bearings are at spaced locations from each other.
